(19) United States
(12) Patent Application Publication
(10) Pub. No.: US 2010/0319059 A1
(43) Pub. Date: Dec. 16, 2010

(54) SIP DIGEST AUTHENTICATION HANDLE CREDENTIAL MANAGEMENT

(75) Inventors: Amit Agarwal, Milpitas, CA (US); David Ahrens, San Jose, CA (US); Martin Westhead, Pacifica, CA (US); Gordon R. Brunson, Broomfield, CO (US); Frank J. Boyle, Denver, CO (US); Harsh V. Mendiratta, Old Bridge, NJ (US); Chandra Ravipati, Thornton, CO (US)

Correspondence Address: SHERIDAN ROSS P.C., 1560 BROADWAY, SUITE 1200, DENVER, CO, 80202, US

(73) Assignee: AVAYA INC., Basking Ridge, NJ (US)

(21) Appl. No.: 12/482,279

(22) Filed: Jun. 10, 2009

(51) Int. Cl. H04L 9/32; G06F 21/00

(52) U.S. Cl. 726/7; 713/183

(57) ABSTRACT

Methods, devices, and systems for controlling access to a password protected resource are provided. More specifically, different communication profiles can be mapped to a single user and that user can utilize a single password to gain access to the password protected resource using any one of his/her communication profiles. Each communication profile may have a unique authentication value associated therewith, but each unique authentication value may be determined based on the single password, thereby eliminating the need for a user to remember multiple passwords for each of his/her communication profiles.

### FIELD OF THE INVENTION

The invention relates generally to communications and more specifically to authentication mechanisms employed in communication networks.

### BACKGROUND

Session Initiation Protocol (SIP) is an open signaling protocol for establishing many kinds of real-time communication sessions. Examples of the types of communication sessions that may be established using SIP include voice, video, and/or instant messaging. These communication sessions may be carried out on any type of communication device such as a personal computer, laptop computer, Personal Digital Assistant (PDA), cellular phone, IM client, IP phone, traditional telephone, and so on.

One key feature of SIP is its ability to use an end-user's Address of Record (AOR) as a single unifying public address for all communications. Thus, in a world of SIP-enhanced communications, a user's AOR becomes their single address that links the user to all of the communication devices associated with the user. Using this AOR, a caller can reach any one of the user's communication devices, also referred to as User Agents (UAs) without having to know each of the unique device addresses or phone numbers.

SIP users may register any number of physical devices (e.g., cell phone, work phone, house phone, laptop, etc.) against their AOR. SIP allows an in-domain AOR to be expressed using any of three (or more) aliases. Traditionally, each alias would require a separate and possibly different password before a user is authentication with that alias. More particularly, a user would have to log-in separately to each alias using the separate password for that alias. This can become cumbersome and confusing if the user has assigned different passwords to each alias or some aliases require a password to be changed more frequently than other aliases.

### SUMMARY

The SIP RFC (RFC 3261) recommends using HTTP Digest Authentication (RFC 2617) to authenticate users. The contents of both RFCs are hereby incorporated herein by reference in their entirety. To authenticate a SIP user, the SIP application or server challenges the user with a realm and a nonce attribute. The following example from RFC 2617 shows an authentication challenge:

```
WWW-Authenticate: Digest
      realm=“testrealm@host.com”,
      qop=“auth,auth-int”,
      nonce=“dcd98b7102dd2f0e8b11d0f600bfb0c093”,
      opaque=“5ccc069c403ebaf9f0171e9517f40e41”
```

The SIP user responds per the RFC with an MD5 hash of (username:realm:password:nonce:cnonce). From RFC 2617:

```
Authorization: Digest username=“Mufasa”,
      realm=“testrealm@host.com”,
      nonce=“dcd98b7102dd2f0e8b11d0f600bfb0c093”,
      uri=“/dir/index.html”,
      qop=auth,
      nc=00000001,
      cnonce=“0a4f113b”,
      response=“6629fae49393a05397450978507c4ef1”,
      opaque=“5ccc069c403ebaf9f0171e9517f40e41”
```

The SIP application or server performs the same calculation and compares its results with that received from the SIP user to authenticate the user (i.e., determine access permissions for the SIP user). The calculation MD5 hash of (username:realm:password) is referred to as HA1 in RFC2617.

A user's passwords are typically stored in Linux, Unix, and Windows operating systems as well as directories as the MD5 hash of a SALT value and the password. Since MD5 is a one-way function, the traditional method of storing passwords as the hash of a SALT value and the password is incompatible with Digest Authentication as there is no way to recover the user's password from the salted hash in order to calculate the MD5 hash of (username:realm:password). This leaves three options for storing the user's credential: (1) in the clear; (2) encrypted; and (3) as an MD5 hash of (username:realm:password).

Option 1 of storing the user's password in the clear is unacceptable as it leaves the user's password exposed and easily accessible to malicious attackers.

Option 2 of storing the user's password in an encrypted state (in a central location that is administrator accessible) requires the decryption key to be distributed to all applications that need access to the user's password. This requirement creates significant key distribution problems. In a large distributed environment, key management is very complex.

Option 3 of storing the user's password as the MD5 hashof (username:realm:password) does not support the SIP requirement where a user may have multiple handles. Accordingly, existing solutions limit a user to a single username and password associated with that username. Available solutions do not meet the requirements for SIP Digest Authentication where a user can have multiple aliases (also referred to as usernames or AORs) and the SIP Digest calculation is incompatible with the MD5 hashof (SALT, password).

These and other needs are addressed by embodiments of the present invention. More specifically, the present invention, in one embodiment, solves the problem of SIP credential management in a distributed call control environment by using a hybrid scheme of Options 2 and 3 identified above. First, the user's password is encrypted and stored as an encrypted password as part of the user record. Second, for each SIP alias belonging to the user, the MD5 hash of (username:realm:password), the HA1 value for the SIP alias, is calculated and stored with that SIP alias.

To authenticate a SIP user, the SIP application/server (or any other type of password protected resource) issues a challenge containing a realm and nonce attribute. The user calculates and sends the response back to the SIP application/server in the form of authentication information. In accordance with at least one embodiment of the present invention, the SIP application/server then retrieves the user record, finds the SIP handle and its corresponding HA1 value and completes the digest calculation. This authentication value is then compared against the authentication information that was received from the user. If the authentication value computed by the SIP application/server matches the authentication information received from the SIP user, then the user is authenticated and allowed access to the SIP application/server or whatever password protected resource was being controlled by the SIP application/server.

In the embodiment described above, since the SIP application/server has access to the HA1 value for the user and their alias, the SIP application/server does not require access to the encryption key used to encrypt the user's password. This eliminates the need to distribute the encryption key to any SIP application/server that has to perform authentication of SIP users. In addition, since the user's authentication credential (i.e., the authentication value for a particular SIP user alias) is calculated based on the user's alias and stored with a logical connection to that alias, the user can have multiple SIP aliases. Moreover, each different authentication value for each of the user's aliases can be calculated with the common password. This eliminated the need for the SIP user to remember multiple passwords when using various aliases. Ultimately this makes SIP more user friendly and secure.

In accordance with at least some embodiments of the present invention, the SIP application/server may be adapted to store the authentication values, rather than relying upon another entity to store the HA1 values for a particular user. As described above, an in-domain AOR may be expressed using any of three (or more) aliases, each representing a single user. “In-domain” means that the AOR is a member of any of the domains or subdomains for which the enterprise is authoritative. Each alias may refer to the same user but in a different expression or format. Assigning three AORs per user provides maximum interoperability with classic private telephony networks, the global PSTN, and the Internet. As an example, the three AORs for the user “John Doe” might be:
3031234567 e.com—This format is called the Enterprise Private Numbering Format. The user part must be a numeric string. It does not include the “+” character but includes the @SIPdomain part. Note: customers may choose E.164 format (without a leading “+”) as their private numbering plan or have no private numbering plan alias at all.
+13031234567@e.com—This format is called E.164 International Format. It includes the “+” character in the first position and the @SIPdomain part.
JohnDoe e.com—This format is called the Alphanumeric Handle Format. It includes the @SIPdomain part and the user part must not be E.164 Internation Format or Private Numbering Format.

All three forms are considered Enterprise canonical because they are core-routable and uniquely represent a single user in every location or site throughout the Enterprise network. All of these AOR formats and the routing for them are provisioned.

In accordance with at least some embodiments of the present invention, each AOR format may have a different and unique authentication value (e.g., hashof (AOR:password)) associated therewith. Each authentication value may be stored at the SIP application/server locally. A user may utilize a single password to authenticate with each AOR or alias (e.g., by matching the AOR's authentication hash). This is possible because the authentication hash for each AOR is based on the common password and the unique part of the AOR. Thus, when a user attempts to authenticate at a SIP application/server with any of the AORs in the Enterprise, the user only has to provide the common password. Before the password is transmitted to the authentication agent at the SIP application/server, user authentication information can be generated based on the input password and part of the AOR. Any hash generation algorithm may be used.

This user authentication hash is compared to the AOR's hash (stored in an internal table in the SIP application/server of the Enterprise). If the two hashes match, then the user is authenticated with the AOR. If the two hashes do not match, then the user is not authenticated with the AOR. Thus, from the user's perspective, only a single password is required to authenticate with multiple AORs; however, each AOR has a unique hash that is used for authentication purposes. If a user changes their password at any point, the hashes for each alias or AOR are recalculated based on the new password and each new hash replaces the old hash for that alias or AOR.

In accordance with at least some embodiments of the present invention, a method for accessing access permissions for a secure network asset is provided that generally comprises:

receiving authentication information from a communication device being operated by a user, the authentication information provided in connection with a request to access the secure network asset, wherein the user has multiple communication profiles, wherein each user communication profile in the multiple communication profiles has a different authentication value associated therewith, and wherein each different authentication value is computed with a common password;

comparing the received authentication information with at least one of the authentication values, the at least one authentication value being associated with a first user communication profile in the multiple communication profiles;

determining that the authentication information matches the at least one authentication value; and

allowing the communication device to access the secure network asset.

In accordance with at least some embodiments of the present invention, the secure network asset may comprise a password protected resource such as a password protected application or hardware device. Alternatively, or in addition, the secure network asset may itself be a password protected resource that does not render its services to a requesting communication device until a valid password (or authentication information based on a valid password) is provided to the secure network asset.

The terms “alias”, “username”, and “AOR” may be used herein to refer to a user's address and/or identity within a network.

The term “computer-readable medium” as used herein refers to any tangible storage and/or transmission medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The terms “determine,” “calculate” and “compute,” and variations thereof, as used herein, are used interchangeably and include any type of methodology, process, mathematical operation or technique.

The term “module”, “agent”, or “tool” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The preceding is a simplified summary of embodiments of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

FIG. 1 is block diagram depicting a first configuration of a communication system in accordance with at least some embodiments of the present invention;

FIG. 2 is a flow diagram depicting a first authentication method in accordance with at least some embodiments of the present invention;

FIG. 3 is a block diagram depicting a second configuration of a communication system in accordance with at least some embodiments of the present invention;

FIG. 4 is a flow diagram depicting a second authentication method in accordance with at least some embodiments of the present invention;

FIG. 5 is a block diagram depicting a third configuration of a communication system in accordance with at least some embodiments of the present invention; and

FIG. 6 is a flow diagram depicting a third authentication method in accordance with at least some embodiments of the present invention.

### DETAILED DESCRIPTION

The invention will be illustrated below in conjunction with an exemplary communication system. Although well suited for use with, e.g., a system using a server(s) and/or database(s), the invention is not limited to use with any particular type of communication system or configuration of system elements. Those skilled in the art will recognize that the disclosed techniques may be used in any communication application in which it is desirable to control access to particular assets in a communication network.

The exemplary systems and methods of this invention will also be described in relation to analysis software, modules, and associated analysis hardware. However, to avoid unnecessarily obscuring the present invention, the following description omits well-known structures, components and devices that may be shown in block diagram form, are well known, or are otherwise summarized.

For purposes of explanation, numerous details are set forth in order to provide a thorough understanding of the present invention. It should be appreciated, however, that the present invention may be practiced in a variety of ways beyond the specific details set forth herein.

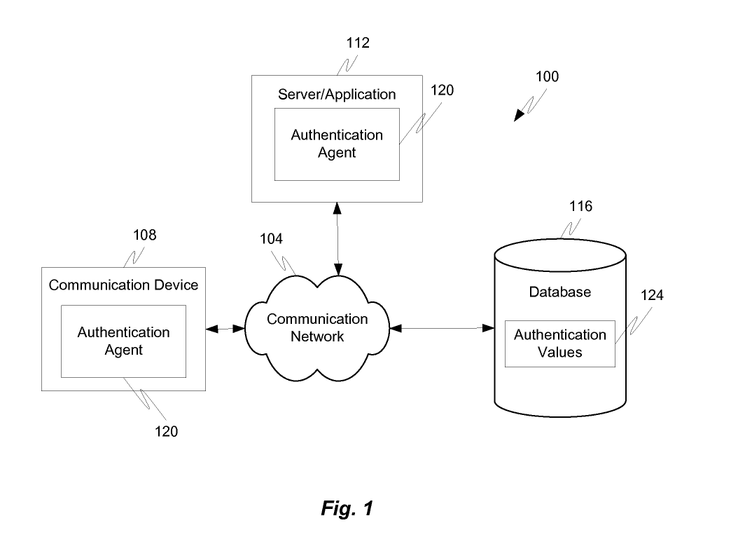

Referring now to FIG. 1, a first configuration of an exemplary communication system 100 will be described in accordance with at least some embodiments of the present invention. The communication system 100 may comprise a communication network 104 that facilitates communications (e.g., voice, image, video, data, and combinations thereof) between various communication devices 108. Additionally, the communication network 104 may allow the communication device 108 to connect with and use resources of a remote application and/or server 112.

The communication network 104 may be any type of known communication medium or collection of communication mediums and may use any type of protocols to transport messages between endpoints. The communication network 104 may include wired and/or wireless communication technologies. The Internet is an example of the communication network 104 that constitutes and IP network consisting of many computers and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, any type of enterprise network, and any other type of packet-switched or circuit-switched network known in the art. In addition, it can be appreciated that the communication network 104 need not be limited to any one network type, and instead may be comprised of a number of different networks and/or network types.

The communication device 108 may be any type of known communication or processing device such as a personal computer, laptop, Personal Digital Assistant (PDA), cellular phone, smart phone, telephone, analog phone, DCP phone, or combinations thereof. The communication device 108 may be controlled by or associated with a single user or may be adapted for use by many users (e.g., an enterprise communication device that allows any enterprise user to utilize the communication device upon presentation of a valid user name and password). In general the communication device 108 may be adapted to support video, audio, text, and/or data communications with other communication devices 108. The type of medium used by the communication device 108 to communicate with other communication devices 108 may depend upon the communication applications available on the communication device 108.

Additionally, a communication device 108 may subscribe to communication services offered by a communication server or remote application 112. As one example, the communication server/application 112 may correspond to a particular web-based communication application that is partially executed on the server/application 112 and partially executed by a communication device 108. One example of such a communication application includes an Instant Messaging (IM) application where the server/application 112 is responsible for sharing certain data about one communication device 108 with another communication device 108 (e.g., presence data related to a presence of a user at a particular communication device 108). The data shared between communication devices 108 via the server/application 112 may help facilitate more seamless communications between the devices.

As another example, the server/application 112 may comprise a SIP functions to the communication device 108. In one embodiment, the communication device 108 may also be controlled by other servers or communication devices external to the communication network 104. In addition to providing SIP functions, the server/application 112 may also include VoIP software, video call software, voice messaging software, recording software, an IP voice server, a fax server, a web server, an email server, and the like.

In accordance with embodiments of the present invention, the server/application 112 can include interfaces for various other protocols such as a Lightweight Directory Access Protocol (LDAP), H.248, H.323, Simple Mail Transfer Protocol (SMTP), Internet Message Access Protocol 4 (IMAP4), Integrated Services Digital Network (ISDN), E/T 1, and analog line or trunk.

The server/application 112 may also include a PBX, an ACD, an enterprise switch, or other type of communications system switch or server, as well as other types of processor-based communication control devices such as media servers, computers, adjuncts, etc.

In accordance with at least one embodiment of the present invention, the server/application 112 may be associated with a password protected resource and may be used to control access to and use of such a resource. In one embodiment, the password protected resource may be remote or separate from the server/application 112. Alternatively, or in addition, the server/application 112 may itself comprise or be a password protected resource, in which case the server/application 112 controls access to itself and/or resources contained therein.

To this extent, the server/application 112 may comprise an authentication agent 120 adapted to receive user authentication information from an authentication agent 120 of the communication device 108 and compare it with authentication values (i.e., valid authentication credentials). Based on this comparison, the authentication agent 120 can determine whether the communication device 108 (and therefore the user of the communication device 108) is allowed to access and/or utilize the password protected resource.

The server/application 112 may be adapted to retrieve at least a portion of the authentication values 124 that are ultimately compared with the authentication information received from the communication device 108. The authentication values 124 (or at least portions thereof) may be retrieved from a central database 116. This central database 116 may be accessible by an administrator that is authorized to maintain certain aspects of the server/application 112 and other related enterprise devices. The central database 116 may, therefore, be configured to maintain both sensitive data (e.g., encrypted passwords, encryption/decryption keys, AORs, etc.) and non sensitive data (e.g., realm information and other basic administrative information).

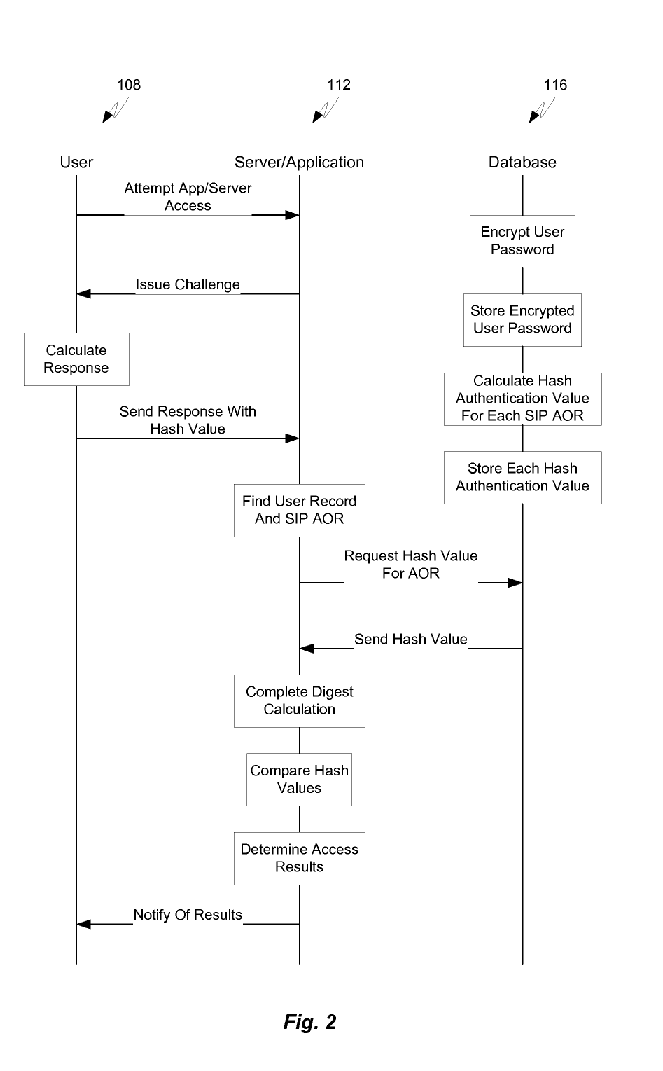

With reference now to FIG. 2, an exemplary method of accessing a password protected resource will be described in accordance with at least some embodiments of the present invention. As noted above, the password protected resource may be protected by and/or reside within the server/application 112. Prior to receiving a user access request the secure access system may be configured and the security settings may be administered or assigned to the appropriate devices in the communication system 100. More specifically, user passwords may be retrieved by a system administrator (either automatically or manually) and those passwords may be encrypted with an encryption key. The key used to encrypt the password may either be a private key used in a symmetric or asymmetric encryption scheme or a public key used in an asymmetric encryption scheme.

Once the password has been encrypted, the encrypted password is stored in the database 116. Furthermore, an authentication value 124 is calculated for a user as a hash based on the user's encrypted password as well as each AOR for that user. Accordingly, multiple authentication values may be calculated for a single user if that user employs more than one AOR.

Additional inputs may be provided to the hash function when calculating the authentication value 124. These inputs may be used to calculate the authentication value 124 before it is stored in the database 116 or may be used in later digest calculations at the server/application 112.

For example, realm information, domain information, and other types of data related to a state associated with the server/application 112 and/or database 116 may be used as an input to the hash function. The hash function used to calculate the authentication value may be an MD5 hash or any other type of known or yet to be developed hash function. Multiple hash functions may also be used in determining a single authentication value.

Each hash value for a particular user is then stored as an authentication value 124 in the database 116. Furthermore, each hash value is stored with a logical mapping to the associated AOR (i. e., the AOR used to calculate the hash value), thereby making it possible to retrieve the appropriate authentication value 124 upon identifying that AOR.

Thereafter, the method continues when a user attempts to access a password protected resource with a communication device 108. The user may attempt obtaining such access by utilizing one of their multiple AORs. In response to the user access attempt, the server/application 112 protecting the password protected resource issues a challenge that is transmitted to the user's communication device 108. The challenge may include a realm and a nonce attribute. These attributes may be included in a challenge message that is transmitted back to the user's communication device 108.

Upon receiving the challenge, the authentication agent 120 at the user's communication device 108 calculates a response to this challenge. The response is generally calculated by first querying the user for a password and then generating a hash value based on the user's password provided to the communication device 108, the AOR being employed by the user, the realm information, and/or the nonce attribute received from the server/application 112. The hash calculation results in the determination of authentication information.

The response value or authentication information calculated by the authentication agent 120 at the communication device 108 is then sent in a response message back to the server/application 112. This response message may be in the form of a SIP message or any other electronic message format supported by the communication network 104.

The server/application 112 receives the response and identifies, if it has not already made such a determination, what AOR is currently being used by the user. The server/application 112 then submits a request to the database 116, where the request identifies the AOR being used by the user and further requests the authentication value 124 that was calculated with that AOR. The database 116 analyzes the request received from the server/application 112 and identifies the associated authentication value 124 for that user's AOR. The identified authentication value 124 is returned to the server/application 112. In an alternative embodiment, the server/application 112 may identify the user requesting access to the password protected resource, indicating that the server/application 112 wants to receive every authentication value 124 for that user. In this case, the database 116 may locate and provide all authentication values 124 associated with that user to the server/application 112.

The authentication value(s) 124 received at the server/application 112 may be a hash value of the user's password and AOR. In this particular case, the authentication agent 120 on the server/application 112 completes the digest calculation by determining a new hash value based on one or more of realm information and a nonce attribute, thereby resulting in a final authentication value. In an alternative embodiment, the authentication value(s) 124 provided to the server/application 112 by the database 116 may already comprise a hash value based on the user's password, AOR, realm information and the nonce attribute. In this case, the authentication agent 120 on the server/application 112 may not need to perform any additional digest calculations.

After a final authentication value 124 is determined by the authentication agent 120 on the server/application 112, the authentication value 124 is compared with the authentication information that was received from the communication device 108. In accordance with at least some embodiments of the present invention, if the same hash function was used at the communication device 108 and the server/application 112 and/or database 116 and the same hash inputs were used to compute the hash functions, then the authentication information should exactly match the authentication value 124. If this is the case, then the authentication agent 120 makes a positive access determination (i.e., determines that the user of the communication device 108 is allowed to access the password protected resource) and takes the necessary steps to allow such access.

If, on the other hand, the authentication information does not match the authentication value 124, then the authentication agent 120 is able to determine that the wrong password was entered by the user or an invalid AOR was used to calculate the hash value for the authentication information. In this case, the authentication agent 120 on the server/application 112 may compare the received authentication information with any additional authentication values 124 associated with that user to determine if there is a match for some other AOR. If no match is found between the authentication information and an authentication value 124, then the authentication agent 120 makes a negative access determination (i.e., determines that the user of the communication device 108 is not allowed to access the password protected resource). In response to making such a determination, the server/application 112 may re-issue the challenge to the user's communication device 108 requesting the user to re-enter their password and/or try another AOR. If the user re-enters their password and/or tries another AOR, then further comparisons may be performed. However, if no additional reply is received, then the method ends and the user is denied access to the password protected resource.

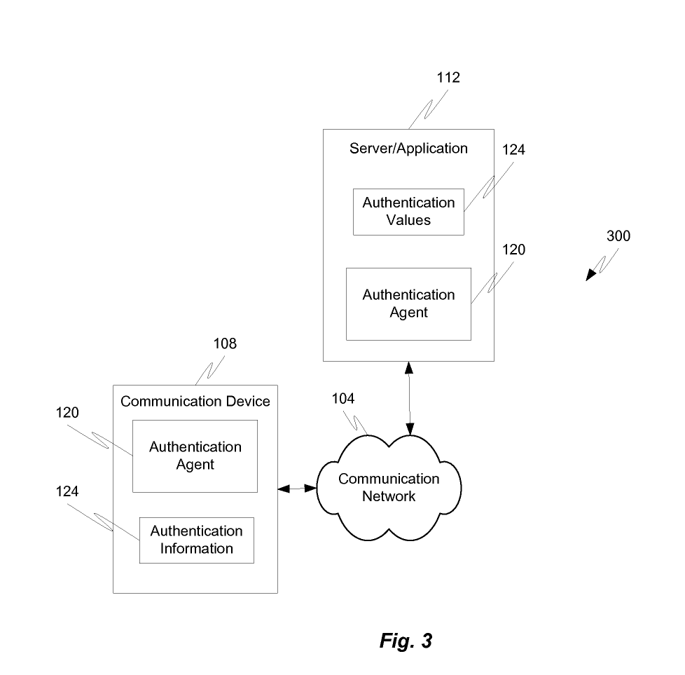

With reference now to FIG. 3, an alternative configuration of a communication system 300 will be described in accordance with at least some embodiments of the present invention. The communication system 300 of FIG. 3 is similar to the communication system 100 depicted in FIG. 1 except that a centralized database 116 is not used to store authentication values 124. Rather, authentication values 124 are stored locally at a network device such as the server/application 112. More specifically, the authentication values 124 are stored at a device that receives and analyzes requests to access a particular password protected resource.

In accordance with at least some embodiments of the present invention, the authentication values 124 stored on the server/application 112 may be hash values determined based on a user's password and AOR. Thus, multiple authentication values 124 associated with a single user (but different user AORs) may be stored at the server/application 112. Additional inputs, such as realm information, may have been used to calculate the authentication values 124, but such inputs are not necessary.

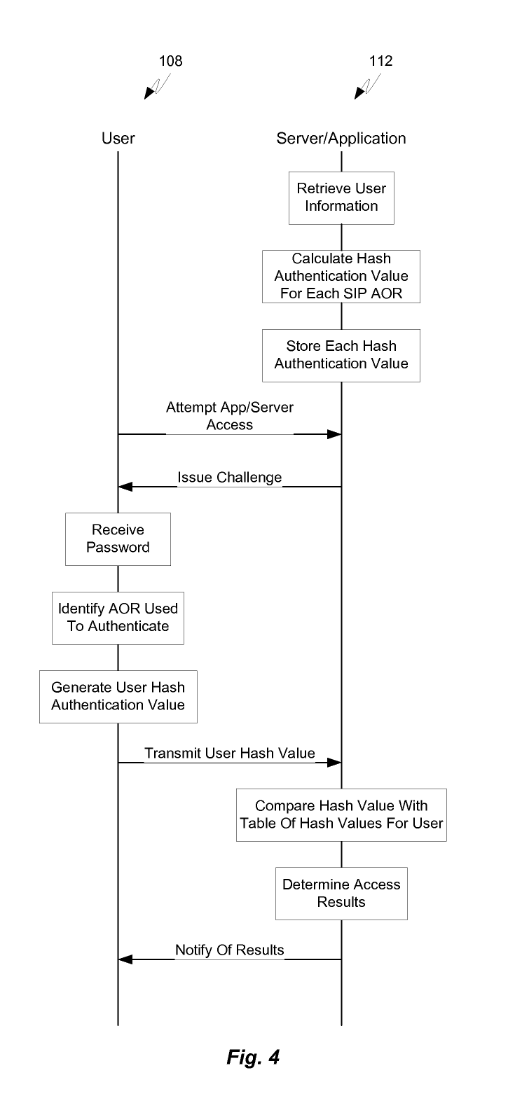

FIG. 4 depicts a second exemplary method of accessing a password protected resource in accordance with at least some embodiments of the present invention. The method begins with the authentication agent 120 on the server/application 112 retrieving user information from an information source. This user information may be provided by a network administrator, from users of communication devices 108, or from an enterprise database. The authentication agent 120 on the server/application 112 then calculates authentication values 124 for the AORs of every network user identified as being allowed to access the password protected resource maintained by the server/application 112. In other words, the authentication agent 120 calculates multiple hash values for each user where each hash value is based on a single password employed by the user and each of the user's AORs. The authentication agent 120 then stores each authentication value 124 in memory of the server/application 112. At this point the server/application 112 has been provisioned and is ready for use in the communication system 300.

The method continues when a user attempts to access a password protected asset associated with the server/application 112. In response to the user's access attempt, the server/application 112 issues a challenge to the user's communication device 108. The challenge may include a request for a valid password from the user. The communication device 108 then relays this request to its user via a user interface (audio and/or graphical) and waits for a user response to the request.

Once the user enters a password, the authentication agent 120 on the communication device 108 identifies the AOR that is currently being employed by the user to communicate in the communication network 300. The authentication agent 120 on the communication device 108 then calculates a hash value (i.e., authentication information) of the user's active AOR as well as the password that has been received from the user. The calculated hash value is then transmitted back to the authentication application 120 on the server/application 112 where it is compared with previously calculated valid authentication values 124. In accordance with at least some embodiments of the present invention, the authentication agent 120 on the server/application 112 compares the authentication information received from the communication device 108 with every authentication value 124 in its table of authentication values 124. If a match is found between the authentication information and one of its authentication values 124, then the authentication agent 120 makes a positive access determination and allows the user access to the password protected asset.

In an alternative embodiment, the authentication agent 120 may limit the number of authentication values 124 compared to the authentication information by identifying the user requesting access and retrieving only the authentication values associated with that user. This may greatly reduce the amount of time required to compare the authentication information with authentication values.

In yet another alternative embodiment, the authentication agent 120 may further limit the number of authentication values 124 compared to the authentication information by identifying the AOR used to calculate the authentication information. In this embodiment, the authentication agent 120 may then retrieve only the authentication value 124 associated with that AOR and perform a single comparison.

One or more of these comparison schemes may be applied by the authentication agent 120 when making a determination of whether a user is allowed to access a password protected resource or not. Based on its determination, the server/application 112 prepares a message for the user and notifies that user of the comparison results. Notification may include actually telling the user that they have been allowed or denied access to the password protected resource as well as providing a reason why such a decision was made. Additionally, if the authentication agent 120 determined that the user is allowed to access the password protected resource, then the notification of results may include providing the user with access to the functionality of the resource.

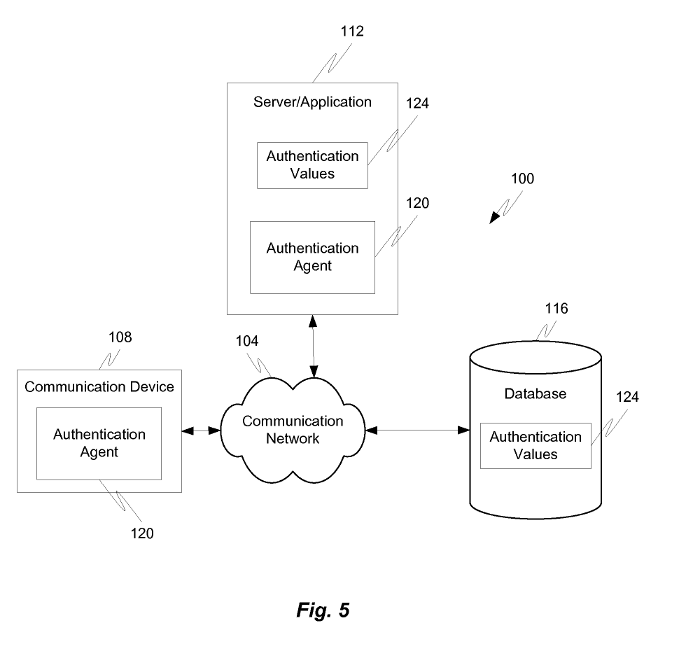

Referring now to FIG. 5, another configuration of a communication system 500 will be described in accordance with at least some embodiments of the present invention. The communication system 500 of FIG. 5 is similar to the communication system 100 depicted in FIG. 1 except that authentication values 124 may be stored in the server/application 112 and in the database 116. As can be appreciated by one skilled in the art multiple instances of the same authentication values 124 may be maintained at each device for redundancy. Alternatively, or in addition, different versions of authentication values 124 may be stored on each device depending upon the state of the communication system 500 or other considerations. Of course, each device may be adapted to store only a portion of a particular authentication value 124 and the combination of information from both sources is required to ultimately obtain a complete version of an authentication value 124.

This particular system configuration is particularly useful in situations where it is desirable to maintain some administrative information locally at the server/application 112 (e.g., user AOR information, realm information, etc.) but it is less desirable to maintain a user's password (usually encrypted) locally. In this embodiment, the user's password may be stored at the central database 116. Moreover, the user may be the only entity allowed to access/change their password. In other words, administrators are not allowed direct or programmatic access to a user's password. Thus, when certain aspects of the system 500 are updated by a system administrator it may be necessary to receive password information from a user before the user's authentication values 124 can be completely updated. In other words, any changes to an administrative attribute may risk locking out all members of that system as the administrator is unable to force a recalculation of user credentials (i.e., authentication values 124) to include the updated attribute.

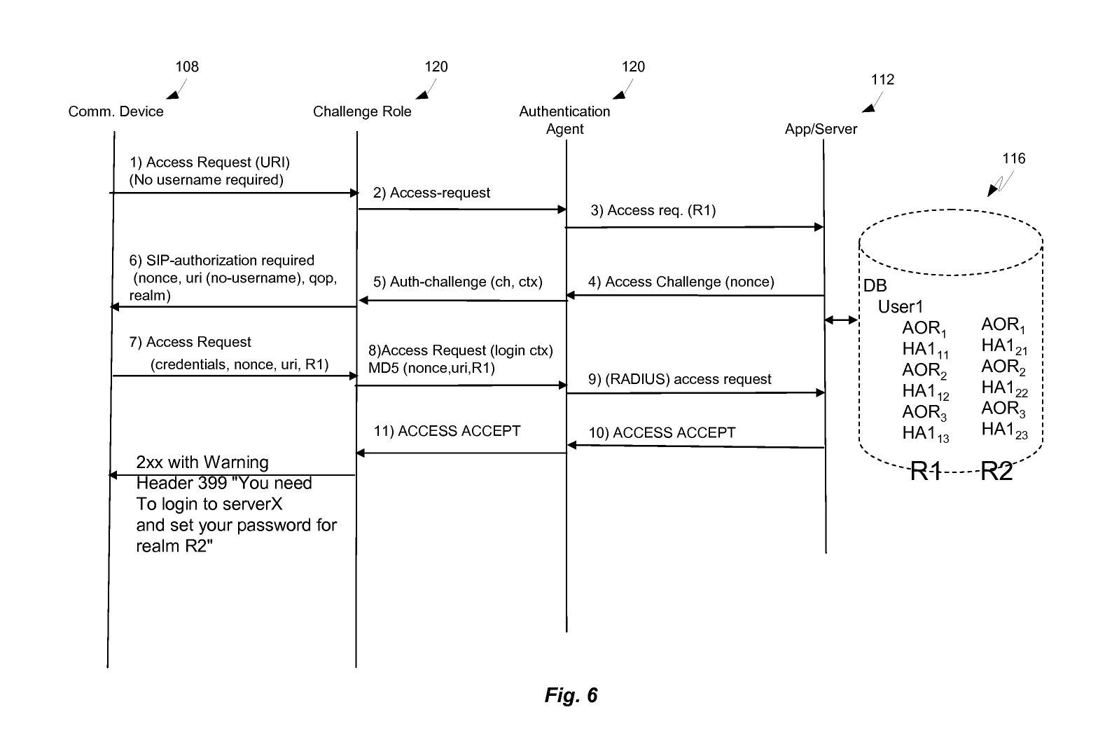

FIG. 6 depicts a method of updating system attributes (e.g., realm information) as well as a third method of accessing a password protected resource in accordance with at least some embodiments of the present invention. The method is initiated when a user's communication device 108 prepares a request to access a password protected resource. The authentication agent 120 on the user's communication device 108 forwards the access request to the authentication agent 120 at the server/application 112. This access request does not necessarily include username information (e.g., an AOR) but does identify the desired resource, possibly via a Uniform Resource Identifier (URI).

The authentication agent 120 on the server/application 112 receives this request and prepares an access challenge that is sent back to the authentication agent 120 of the communication device 108. As can be seen in FIG. 6, the authentication challenge is based on a first instance of realm information. However, the actual realm information has been changed to a second instance of realm information, likely by a system administrator. This results in the attempted calculation of new authentication values for each user belonging to that realm. However, since the administrator has not been granted access to the user passwords, the calculation of the new authentication values is incomplete. Accordingly, the database 116 maintains the authentication values for the first instance of realm information as well as the incomplete authentication values for the second instance of realm information until a user has provided an updated password. This is why the authentication challenge is based on the first instance of realm information rather than the second instance of realm information.

The challenge is then presented to a user of the communication device 108 indicating that appropriate credentials (e.g., a password) are required to gain access to the password protected asset. The user inputs their previous password and the authentication agent 120 of the communication device 108 calculates a hash value (i.e., authentication information) based on the password provided by the user, the user's AOR currently being used, and any other information (e.g., nonce attribute, first realm information, URI, etc.). This authentication information is then transmitted to the authentication agent 120 of the server/application 112 where it is compared with the authentication values for the first realm.

In the example depicted in FIG. 6, the authentication agent 120 on the server/application 112 determines that the user has provided authentication information that matches an authentication value stored for that user in the database 116 in association with the first instance of realm information. Accordingly, the authentication agent 120 initiates an access accept action and notifies the user of the same. However, in addition to notifying the user that access to the password protected resource has been allowed, the authentication agent 120 also notifies the user that the system administrator has changed the realm information to a second instance of realm information and the user needs to set their common password for the new realm information. The user then provides the new password (which can be the same as the old password) to the server/application 112 such that the new authentication values based on the second instance of realm information are calculated for the user. Once the new authentication values are calculated based on the user-provided password, the old authentication values 124 based on the first instance of realm information may be removed from the database 116.

While the above-described flowchart has been discussed in relation to a particular sequence of events, it should be appreciated that changes to this sequence can occur without materially effecting the operation of the invention. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols of this invention can be implemented on a special purpose computer in addition to or in place of the described communication equipment, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a server, personal computer, any comparable means, or the like. In general, any device capable of implementing a state machine that is in turn capable of implementing the methodology illustrated herein can be used to implement the various communication methods, protocols and techniques according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The analysis systems, methods and protocols illustrated herein can be readily implemented in hardware and/or software using any known or later developed systems or structures, devices and/or software by those of ordinary skill in the applicable art from the functional description provided herein and with a general basic knowledge of the communication and computer arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with the present invention, systems, apparatuses and methods for securing password protected resources. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. A method of assessing access permissions for a secure network asset, comprising:
receiving authentication information from a communication device being operated by a user, the authentication information provided in connection with a request to access the secure network asset, wherein the user has multiple communication profiles, wherein each user communication profile in the multiple communication profiles has a different authentication value associated therewith, and wherein each different authentication value is computed with a common password;
comparing the received authentication information with at least one of the authentication values, the at least one authentication value being associated with a first user communication profile in the multiple communication profiles;
determining that the authentication information matches the at least one authentication value; and
allowing the communication device to access the secure network asset.

2. The method of claim 1, wherein the authentication information includes a hash value determined by a combination of the common password and a profile identifier associated with the first user communication profile.

3. The method of claim 2, wherein the profile identifier is an Address of Record.

4. The method of claim 2, wherein the hash value is further determined based on a realm of at least one of the communication device and secure network asset.

5. The method of claim 2, further comprising:
identifying the profile identifier currently being used by the communication device;
requesting the at least one authentication value from a database, wherein the request includes the identified profile identifier;
receiving the requested at least one authentication value at the secure network asset; and
comparing, at the secure network asset, the requested at least one authentication value with the authentication information.

6. The method of claim 5, further comprising:
encrypting the common password; and
storing the encrypted common password in the database.

7. The method of claim 1, further comprising:
storing the different authentication values associated with the multiple communication profiles at the secure network asset; and
comparing, at the secure network asset, the authentication information with each authentication value associated with the user until a match between the authentication information and the at least one authentication value is found.

8. The method of claim 1, further comprising:
storing the authentication values associated with the multiple communication profiles in an administrator accessible database;
determining that an administrator has changed at least one variable that was used to calculate the authentication values, wherein the at least one variable is not the common password;
calculating new authentication values for each communication profile while maintaining the authentication values calculated prior to the administrator changing the at least one variable;
thereafter, requesting a second common password from the user;
receiving the second common password from the user;
re-calculating the new authentication values for each communication profile based on the second common password;
discarding the authentication values calculated prior to the administrator changing the at least one variable; and
storing the new authentication values in the administrator accessible database.

9. The method of claim 8, wherein the second common password is the same as the common password.

10. A computer readable medium encoded with processor executable instructions operable to, when executed, perform the method of claim 1.

11. A secure network asset, comprising:
an authentication agent operable to control user access to a password protected resource, the authentication agent adapted to receive authentication information from a communication device being operated by a user, the authentication information provided to the secure network asset in connection with a request to access the password protected resource, wherein the user has multiple communication profiles, wherein each user communication profile in the multiple communication profiles has a different authentication value associated therewith, and wherein each different authentication value is computed with a common password, the authentication agent being further adapted to compare the received authentication information with at least one of the authentication values, determine that the authentication information matches the at least one authentication value, and allow the communication device to access the password protected resource.

12. The asset of claim 11, wherein the password protected resource resides on the secure network asset.

13. The asset of claim 11, wherein the password protected resource is remote to the secure network asset.

14. The asset of claim 11, wherein the at least one authentication value is associated with a first user communication profile in the multiple communication profiles, wherein the authentication information includes a hash value determined by a combination of the common password and a profile identifier associated with the first user communication profile.

15. The asset of claim 14, wherein the profile identifier is an Address of Record.

16. The asset of claim 14, wherein the authentication agent is further operable to identify the profile identifier currently being used by the communication device, request the at least one authentication value from a database, wherein the request includes the identified profile identifier, receive the requested at least one authentication value at the secure network asset, and compare the requested at least one authentication value with the authentication information.

17. The asset of claim 16, wherein the common password is encrypted and stored as an encrypted password in the database.

18. The asset of claim 11, wherein the secure network asset is further operable to store the different authentication values associated with the multiple communication profiles and wherein the authentication agent is adapted to compare the authentication information with each authentication value associated with the user until a match between the authentication information and the at least one authentication value is found.

19. The asset of claim 11, wherein the authentication values associated with the multiple communication profiles are stored in an administrator accessible database, wherein the authentication agent is further operable to determine that an administrator has changed at least one variable that was used to calculate the authentication values, wherein the at least one variable is not the common password, calculate new authentication values for each communication profile, and thereafter, request a second common password from the user that will be used to re-calculate the new authentication values.

20. The asset of claim 19, wherein the second common password is different from the common password.
